(19) United States
(12) Patent Application Publication
(10) Pub. No.: US 2004/0032640 A1
(43) Pub. Date: Feb. 19, 2004

(54) Optical transmission system and optical amplification method

(76) Inventors: Toshiyuki Miyamoto, Yokohama-shi (JP); Motoki Kakui, Yokohama-shi (JP); Masayuki Shigematsu, Yokohama-shi (JP)

Correspondence Address: MCDERMOTT, WILL & EMERY, 600 13th Street, N.W., Washington, DC, 20005-3096, US

(21) Appl. No.: 10/462,833

(22) Filed: Jun. 17, 2003

(30) Foreign Application Priority Data
Jun. 18, 2002 (JP) P2002-177490

(51) Int. Cl. H01S 3/00

(52) U.S. Cl. 359/334

(57) ABSTRACT

The present invention relates to an optical transmission system and others with excellent noise characteristics. The optical transmission system is provided with an optical fiber transmission line through which signal light propagates, an optical device, and a Raman amplifier placed upstream of the optical device. The optical device functions as an element that degrades a noise characteristic in a signal wavelength band from the long wavelength side toward the short wavelength side when a desired gain is given to the signal light propagating in the optical fiber transmission line. On the other hand, the Raman amplifier is configured so as to adjust optical powers of respective pumping channels in pumping light and thereby Raman-amplify the signal light so that optical powers of the signal channels increase from the long wavelength side toward the short wavelength side in the signal wavelength band, in order to improve the noise characteristic of the whole optical fiber transmission line. Since the Raman amplifier preliminarily Raman-amplifies before injected into the optical device, it is feasible to relieve influence of the optical device on the noise characteristic and reduce variation of the noise figure in the whole system.

### BACKGROUND OF THE INVENTION

1. Field of the Invention

The present invention relates to an optical transmission system for transmitting multiplexed signal light containing a plurality of signal channels of mutually different wavelengths and a method of amplifying the multiplexed signal light in the optical transmission system.

2. Related Background Art

A WDM (Wavelength Division Multiplexing) optical transmission system includes an optical fiber transmission line through which signal light wherein a plurality of signal channels in a predetermined signal wavelength band are multiplexed (multiplexed signal light) propagates, and enables fast transmission and reception of large volume of information. Optical amplifiers are used in order to compensate for transmission losses occurring during propagation of the signal light through the optical fiber transmission line.

There are several types of such optical amplifiers conventionally known. For example, rare-earth-doped optical fiber amplifiers are optical amplifiers using an optical fiber with an optical waveguide region doped with a rare earth element (e.g., Er or Tm), as an optical amplifying medium and arranged to excite the rare earth element under supply of pumping light of a predetermined wavelength into the optical fiber. The excitation of the rare earth element can induce amplification of the signal light in a specific signal wavelength band according to an energy difference between an excited level and the ground level of the rare earth element.

Raman amplifiers are optical amplifiers utilizing the stimulated Raman scattering, which is a kind of the nonlinear optical phenomena in the optical transmission line through which the signal light propagates; for example, where the optical transmission line is a silica optical fiber, light of a wavelength approximately 100 nm shorter than the wavelength of the signal light is used as pumping light for Raman amplification. Semiconductor optical amplifiers are optical amplifiers that cause population inversion in a semiconductor under supply of electric current and amplify the signal light in a specific wavelength band according to the energy difference in the population inversion.

Among these various optical amplifiers, each of the rare-earth-doped optical fiber amplifiers and semiconductor optical amplifiers is commonly utilized as a modularized, lumped optical amplifier. On the other hand, the Raman amplifiers can not be utilized only as lumped optical amplifiers, but can also be utilized as distributed optical amplifiers. The distributed Raman amplifiers include no modularized optical transmission line as an optical amplifying medium, and implement Raman amplification of the signal light in the optical fiber transmission line installed in a repeating interval.

On the other hand, in order to achieve larger capacity, there are desires for expansion of the signal wavelength bands applied to the WDM optical transmission systems. Namely, in addition to the C band (1530 nm-1565 nm) having been used heretofore, the L band (1565 nm-1625 nm) longer than that is being used and use of the S band (1460 nm-1530 nm) shorter than that is also under study.

### SUMMARY OF THE INVENTION

The Inventors examined the conventional optical transmission systems and found the following problem. Namely, in the case where the WDM optical transmission is carried out in a wide band including the S, C, and L bands and where the signal light of plural signal channels is amplified by the optical amplifier, there arises the problem of variation of Noise Figure (NF) among the signal channels. Here the noise figure NF is defined by the equation below.

NF=P_{ASE}/(h·ν·Δν·G) (1)

P_{ASE} represents the optical power of ASE light (Amplified Spontaneous Emission Light) generated in the optical amplifier. Furthermore, h indicates the Planck constant, ν the frequency of the signal light, Δν the frequency resolution of the signal light, and G the gain of the optical amplifier. If the variation of the noise figure is large in the signal wavelength band, the system must be designed so as to match the worst value of the noise figure; therefore, it imposes restrictions on the transmission capacity and optical repeating distance.

The present invention has been accomplished in order to solve the above problem and an object of the invention is to provide an optical transmission system and an optical amplification method with excellent noise characteristics.

An optical transmission system according to the present invention is a system comprising an optical fiber transmission line; and a lumped optical amplifier, such as a Raman amplifier, a rare-earth-doped optical fiber amplifier, or a semiconductor optical amplifier, as an optical device capable of functioning as an element that degrades a noise characteristic in a signal wavelength band when a desired gain is given to signal light propagating in the optical fiber transmission line, and the system has a structure for improving the noise characteristic of the whole system.

In the optical transmission system wherein the lumped optical amplifier is placed on the optical fiber transmission line, the power of the signal light is more lowered on the short wavelength side than on the long wavelength side because of influence of wavelength dependence of losses in the optical fiber transmission line and power transition due to stimulated Raman scattering between the signal channels (SRS tilt: Stimulated Raman Scattering Tilt). Consequently, the gain of the lumped optical amplifier becomes larger on the short wavelength side than on the long wavelength side and thus the noise figure in the signal wavelength band becomes more degraded on the short wavelength side than on the long wavelength side in the whole optical fiber transmission line including the lumped optical amplifier. Therefore, the optical transmission system according to the present invention further comprises a Raman amplifier, in order to improve the noise characteristic of the whole optical fiber transmission line including the lumped optical amplifier. This Raman amplifier may be either a distributed Raman amplifier or a lumped Raman amplifier and is located upstream of the aforementioned lumped optical amplifier. In particular, this Raman amplifier preliminarily Raman-amplifies the signal light to be injected into the lumped optical amplifier, so as to increase optical powers of the signal channels from the long wavelength side toward the short wavelength side in the signal wavelength band.

In the case where the above Raman amplifier is a distributed Raman amplifier, the system comprises a pumping light source system for emitting pumping light including a plurality of pumping channels of mutually different wavelengths, and part of the optical fiber transmission line located upstream of the transmission line element functions as a Raman-amplification optical fiber into which the pumping light from the pumping light source system is supplied. In this case, in the pumping light source system for the distributed Raman amplifier, optical powers of the respective pumping channels are adjusted so that the optical powers of the signal channels in the Raman-amplified signal light increase from the long wavelength side toward the short wavelength side.

Furthermore, an optical amplification method according to the present invention is adapted to an optical transmission system comprising an optical fiber transmission line through which signal light with a plurality of signal channels of mutually different wavelengths in a signal wavelength band propagates; and an optical device placed on the optical fiber transmission line and being capable of functioning as an element that degrades a noise characteristic in the signal wavelength band from the long wavelength side toward the short wavelength side when a desired gain is given to the signal light propagating in the optical fiber transmission line, and the method comprises a first optical amplification step, and a second optical amplification step carried out subsequent to the first optical amplification step, in order to improve the noise characteristic.

Specifically, the first optical amplification step is to supply pumping light of plural channels into part of the optical fiber transmission line located upstream of the optical device and thereby preliminarily Raman-amplify the signal light so as to increase optical powers of the signal channels from the long wavelength side toward the short wavelength side in the signal wavelength band. The second optical amplification step is to guide the above signal light Raman-amplified in the whole optical fiber transmission line in the first optical amplification step, to the optical device and further amplify the signal light in the optical device.

According to the present invention, the signal light with the plurality of signal channels is first amplified by the Raman amplifier, preferably, by the distributed Raman amplifier and thereafter is further amplified by the lumped optical amplifier. The gain characteristic of the whole system is the sum of gain characteristics of the respective distributed Raman amplifier and lumped optical amplifier. The signal light outputted from the distributed Raman amplifier, before injected into the lumped optical amplifier, is in a state in which the optical powers of the signal channels increase from the long wavelength side toward the short wavelength side in the signal wavelength band. The lumped optical amplifier is the element that degrades the noise figure of the whole optical fiber transmission line in the signal wavelength band from the short wavelength side toward the long wavelength side, and the gain spectrum of the Raman amplifier is preliminarily adjusted so as to be larger on the short wavelength side in the signal wavelength band, whereby the gain necessary for the whole system is secured even with the decrease of the gain on the short wavelength side, so as to relieve the degradation factor of the noise characteristic. When the signal light is Raman-amplified so as to increase the optical power more on the shorter wavelength side, prior to the injection of the signal light into the degradation factor of the noise characteristic, as described above, it is feasible to effectively reduce the variation of the noise figure in the signal wavelength band while securing the gain necessary for the whole system.

A difference between an optical power in a signal channel of a shortest wavelength and an optical power in a signal channel of a longest wavelength in the signal wavelength band, among the signal channels in the signal light outputted from the Raman amplifier, is preferably 2 dB or more. As a noise characteristic at an output port of the lumped optical amplifier being a transmission line element, a difference between a minimum noise figure and a maximum noise figure in the signal wavelength band is preferably 2 dB or less.

### BRIEF DESCRIPTION OF THE DRAWINGS

FIG. 1 is a diagram showing a configuration of an embodiment of the optical transmission system according to the present invention;

FIGS. 2A-2C are graphs for explaining the operation of the optical transmission system shown in FIG. 1;

FIGS. 3A and 3B are graphs showing transmission loss and chromatic dispersion characteristics of the optical fiber in the lumped optical amplifier in the optical transmission system shown in FIG. 1;

FIG. 4 is a table containing a list of wavelengths and powers of Raman-amplification pumping beams in each of Embodiment of the optical transmission system according to the present invention and Comparative Example;

FIGS. 5A and 5B are graphs showing gain and noise characteristics (noise figure) in each of Embodiment of the optical transmission system according to the present invention and Comparative Example; and

FIGS. 6A and 6B are graphs showing MPI crosstalk and nonlinear phase shift characteristics in each of Embodiment of the optical transmission system according to the present invention and Comparative Example.

### DETAILED DESCRIPTION OF THE PREFERRED EMBODIMENTS

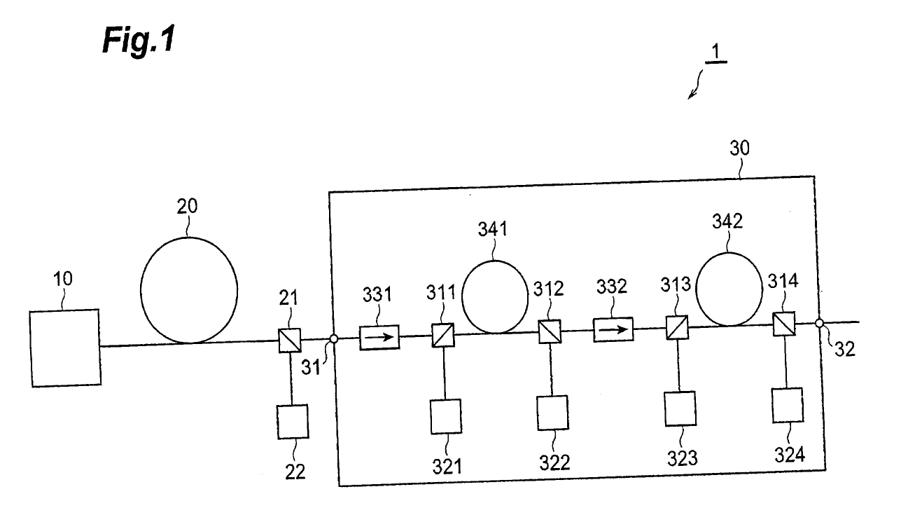

Each embodiment of the optical transmission system and others according to the present invention will be described below in detail with reference to FIGS. 1, 2A-3B, 4, and 5A-6B. The same reference symbols will denote the same elements throughout the description of the drawings, without redundant description.

FIG. 1 is a diagram showing a configuration of an embodiment of the optical transmission system according to the present invention. This optical transmission system 1 is provided with optical transmitter 10, optical fiber transmission line 20, and lumped optical amplifier 30. An optical coupler 21 is located in the vicinity of the terminal end of optical fiber transmission line 20 and a pumping light source 22 (included in the pumping light source system) is coupled to the optical coupler 21.

The optical transmitter 10 outputs signal light with a plurality of signal channels of mutually different wavelengths (multiplexed signal light) included in a desired signal wavelength band. The optical fiber transmission line 20 is installed in a repeating interval between optical transmitter 10 and lumped optical amplifier 30 and transmits the multiplexed signal light outputted from the optical transmitter 10, to the lumped optical amplifier 30. The lumped optical amplifier 30 is of modularized structure and is set in an optical repeater or in an optical receiver. The multiplexed signal light having propagated through the optical fiber transmission line 20 is injected through input port 31 into the lumped optical amplifier. The injected multiplexed signal light is amplified in a lump and thereafter is outputted through output port 32 into an optical fiber transmission line to a receiver.

The pumping light source 22 outputs pumping light of one or more pumping channels (Raman-amplification pumping light). The optical coupler 21 supplies the Raman-amplification pumping light outputted from the pumping light source 22, in the opposite direction to the propagating direction of the multiplexed signal light into the optical fiber transmission line 20. This optical coupler 21 outputs the multiplexed signal light coming through the optical fiber transmission line 20, toward the lumped optical amplifier 30. Namely, these optical fiber transmission line 20, optical coupler 21, and pumping light source 22 constitute a distributed Raman amplifier for Raman-amplifying the signal light while transmitting the signal light of the signal channels in the signal wavelength band through the optical fiber transmission line 20 under supply of the Raman-amplification pumping light. In particular, this distributed Raman amplifier outputs the multiplexed signal light so that the optical powers of the signal channels increase with decrease of the wavelength in the signal wavelength band.

The optical fiber transmission line 20 may be any optical fiber, for example, selected from a standard single-mode optical fiber having the zero-dispersion wavelength near the wavelength of 1.3 μm, a non-zero dispersion-shifted optical fiber having the zero-dispersion wavelength on the longer wavelength side than the wavelength of 1.3 μm and having a small positive wavelength dispersion at the wavelength of 1.55 μm, a zero-dispersion shifted optical fiber having the zero-dispersion wavelength near the wavelength of 1.55 μm, a pure silica core optical fiber having the core region substantially made of pure silica glass and the cladding region doped with F, a single-mode optical fiber whose effective area is larger than those of the ordinary optical fibers, and so on. The optical fiber transmission line 20 may also be of structure in which two or more optical fibers out of these fibers are coupled, or of structure in which one or more optical fibers out of the foregoing fibers are coupled to a dispersion compensating optical fiber.

The lumped optical amplifier 30 may be any one of the rare-earth-doped optical fiber amplifiers, Raman amplifiers, and semiconductor optical amplifiers. The rare-earth-doped optical fiber amplifiers include a type using an optical fiber doped with Er, as an optical amplifying medium and amplifying the signal light of the C band or the L band, and a type using an optical fiber doped with Tm, as an optical amplifying medium and amplifying the signal light of the S band. If the optical fiber transmission line 20 has a large absolute value of cumulative chromatic dispersion, the lumped optical amplifier 30 is preferably one also having a dispersion compensating function.

If the repeating span is so long as to give rise to a large transmission loss, the lumped optical amplifier 30 is preferably one of multistage structure, in order to achieve the desired gain. Particularly, in the case where the repeating span is long and the lumped optical amplifier 30 is a Raman amplifier, the lumped optical amplifier 30 of the multistage structure is suitable, not only for achieving the desired gain, but also for reducing influence of Rayleigh-scattered light and double-Rayleigh-scattered light occurring inside the optical amplifier.

In the optical transmission system 1 shown in FIG. 1, the lumped optical amplifier 30 is a Raman amplifier of two-stage structure. Namely, in the order along the signal light propagation path from the input port 31 toward the output port 32 (the propagation path constituting part of the optical fiber transmission line provided between optical transmitter 10 and the optical receiver), the lumped optical amplifier 30 is provided with optical isolator 331, optical coupler 311, optical fiber 341, optical coupler 312, optical isolator 332, optical coupler 313, optical fiber 342, and optical coupler 314 and is also provided with pumping light source 321 connected to the optical coupler 311, pumping light source 322 connected to the optical coupler 312, pumping light source 323 connected to the optical coupler 313, and pumping light source 324 connected to the optical coupler 314.

Each of the optical isolators 331, 332 allows light to pass in the forward direction from the input port 31 toward the output port 32 but does not allow light to pass in the backward direction. Each of the pumping light sources 321-324 outputs Raman-amplification pumping light.

The optical coupler 311 supplies the Raman-amplification pumping light coming from the pumping light source 321, into the optical fiber 341 (co-pumping or forward pumping), and outputs the signal light coming from the optical isolator 331, into the optical fiber 341. The optical coupler 312 supplies the Raman-amplification pumping light coming from the pumping light source 322, into the optical fiber 341 (counter-pumping or backward pumping), and outputs the signal light coming from the optical fiber 341, to the optical isolator 332.

The optical coupler 313 supplies the Raman-amplification pumping light coming from the pumping light source 323, into the optical fiber 342 (forward pumping), and outputs the signal light coming from the optical isolator 332, into the optical fiber 342. The optical coupler 314 supplies the Raman-amplification pumping light coming from the pumping light source 324, into the optical fiber 342 (backward pumping), and outputs the signal light coming from the optical fiber 342, to the output port 32.

Each of the optical fibers 341, 342 is an optical amplifying medium that amplifies the signal light in a lump under supply of the Raman-amplification pumping light. The optical fiber 341 Raman-amplifies the signal light injected thereinto through the optical coupler 311, by the Raman-amplification pumping beams from the pumping light sources 321, 322, supplied through the optical couplers 311, 312, and outputs the Raman-amplified signal light to the optical coupler 312. The optical fiber 342 Raman-amplifies the signal light injected thereinto through the optical coupler 313, by the Raman-amplification pumping beams from the pumping light sources 323, 324, supplied through the optical couplers 313, 314, and outputs the Raman-amplified signal light to the optical coupler 314.

Each of the optical fibers 341, 342 may be any one of the various optical fibers described above, or may be one, for example, selected from a dispersion compensating optical fiber having negative chromatic dispersion, a highly nonlinear optical fiber having a large nonlinear refractive index or a small effective area, a holey optical fiber in which longitudinally extending holes are distributed in a cross section in order to implement a predetermined index profile and desired optical characteristics, and so on. Each of the optical fibers 341, 342 may be of structure in which two or more optical fibers out of those are coupled.

Each of the optical fibers 341, 342 preferably has a function of compensating for the chromatic dispersion of the optical fiber transmission line and also preferably compensates for the dispersion slope of the optical fiber transmission line. In this case, each of the optical fibers 341, 342 may compensate for the chromatic dispersion in the whole signal wavelength band by an optical fiber of a single kind, or may compensate for the chromatic dispersion in the whole signal wavelength band by a combination of optical fibers of two or more kinds.

Each of the pumping light sources 21 and 321-324 preferably includes a beam source unit, for example, such as a Fabry-Perot type semiconductor laser source (FP-LD), a fiber grating laser source configured to stabilize output wavelengths by a combination of the FP-LD with an optical fiber grating, a distributed feedback laser source, a Raman laser source, and so on.

Each of the pumping light sources 21 and 321-324 is preferably configured to output pump beams of plural wavelengths, in order to obtain a desired gain spectrum across a wide band. In this case, each of the pumping light sources 21 and 321-324 includes a plurality of beam source units for outputting pump beam components (corresponding to respective pumping channels) included in the Raman-amplification pumping light and an optical multiplexer for multiplexing the pump beam components outputted from these beam source units and outputting multiplexed light.

When the beam source units in each pumping light source have polarization dependence, each of the pumping light sources 21 and 321-324 preferably includes a polarization combiner for polarization-combining the pump beam components from the respective beam source units and may include a depolarizer for depolarizing the pumping light from the beam source units.

Each of the optical fiber transmission line 20 and the optical fibers 341, 342 being the optical amplifying media in which Raman amplification is effected, may be one in which the pumping light is supplied in the same direction as the signal light propagating direction (co-pumping) or one in which the pumping light is supplied in the direction opposite to the signal light propagating direction (counter-pumping) They may be those in which the pumping light is supplied in the both directions (bidirectional pumping). In the optical transmission system 1 shown in FIG. 1, the optical fiber transmission line 20 is counter-pumped, and each of the optical fibers 341, 342 is bidirectionally pumped.

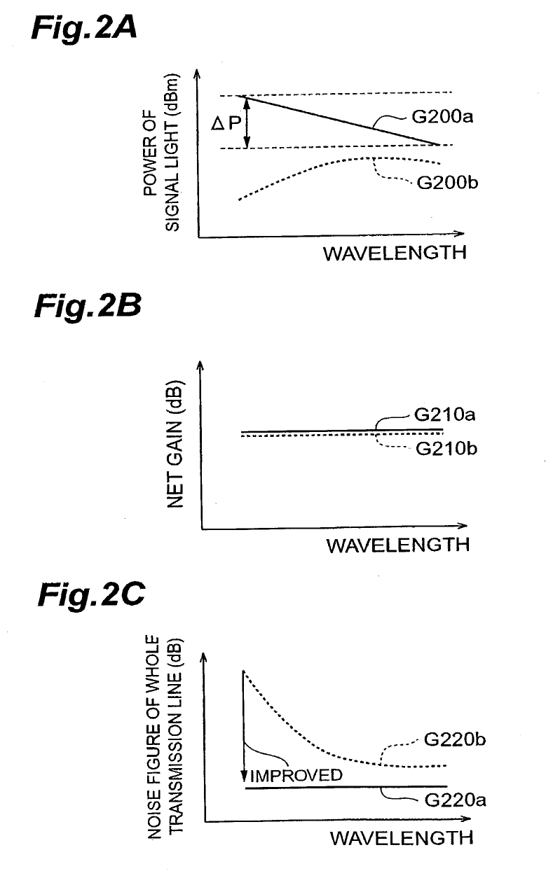

FIGS. 2A-2C are graphs for explaining the operation of the optical transmission system 1 shown in FIG. 1. FIG. 2A shows the wavelength characteristics of power (power spectra) of the signal light after having propagated through the optical fiber transmission line 20, in which graph G200a indicates the power spectrum of Embodiment and graph G200b the power spectrum of Comparative Example. FIG. 2B shows the gain characteristics of the whole optical transmission system 1, in which graph G210a indicates NET gain of Embodiment and graph G210b NET gain of Comparative Example. FIG. 2C shows the noise characteristics after the amplification in the lumped optical amplifier 30, in which graph G220a indicates the noise figure of Embodiment and graph G220b the noise figure of Comparative Example. The optical transmission system of Embodiment is provided, as shown in FIG. 1, with the optical fiber transmission line 20, lumped optical amplifier 30, and distributed constant type Raman amplifier using the optical fiber transmission line 20 as a Raman-amplification optical fiber. On the other hand, the optical transmission system of Comparative Example is provided with the optical fiber transmission line 20 and lumped optical amplifier 30, as the system of Embodiment is, but does not have the structure for Raman-amplifying the signal light before arrival at the lumped optical amplifier 30.

The signal light with a plurality of signal channels in the signal wavelength band is outputted from the optical transmitter 10 into the optical fiber transmission line 20, in a state in which the signal channels are multiplexed. Since the Raman-amplification pumping light is supplied from the pumping light source 22 into the optical fiber transmission line 20, the signal light is Raman-amplified during the propagation through the optical fiber transmission line 20, The multiplexed signal light, after having propagated through the optical fiber transmission line 20, demonstrates higher power at shorter wavelengths of the signal channels, as described above, and the difference ΔP between the optical powers of signal channels at the shortest wavelength and at the longest wavelength in the signal wavelength band is preferably 2 dB or more (graph G200a in FIG. 2A). In the case where the signal light is not Raman-amplified in the optical fiber transmission line 20 (Comparative Example), the optical power becomes smaller on the short wavelength side (graph G200b in FIG. 2A) because of the influence of the wavelength characteristics of transmission losses in the optical fiber transmission line 20 and the power transition due to stimulated Raman scattering occurring between signal channels.

The signal light, having propagated through the optical fiber transmission line 20, travels via the input port 31 into the lumped optical amplifier 30, then is amplified by this lumped optical amplifier 30, and thereafter is outputted through the output port 32. At this time, the wavelengths and optical powers of the pumping channels outputted from the respective pumping light sources 321-324 are properly set to control the amplification operation in the lumped optical amplifier 30 so that the optical powers of the respective signal channels outputted from the lumped optical amplifier 30 become constant. Namely, the amplification operation in the lumped optical amplifier 30 is controlled so that the wavelength dependence of the total gain of the whole system including the distributed Raman amplifier, which includes the optical fiber transmission line 20, and the lumped optical amplifier 30 becomes flat (FIG. 2B).

In the present invention, therefore, the signal light injected into the lumped optical amplifier 30 has the powers of the signal channels increasing with decrease of their wavelength and thus the gain spectrum of the lumped optical amplifier 30 is set so as to become lower with decrease of the wavelength; for this reason, an improvement is made in the noise figure after the amplification in the lumped optical amplifier 30 (graph G220a in FIG. 2C) The variation of the noise figure in the signal wavelength band (=maximum noise figure−minimum noise figure) is preferably 2 dB or less. On the other hand, in Comparative Example the signal light injected into the lumped optical amplifier 30 has the powers of the signal channels decreasing with decrease of their wavelength and thus the gain spectrum of the lumped optical amplifier 30 is set so as to become higher with decrease of the wavelength; therefore, the noise figure after the amplification in the lumped optical amplifier 30 becomes heavily degraded on the short wavelength side (graph G220b in FIG. 2C).

A specific configuration of Embodiment of the optical transmission system according to the present invention will be described together with Comparative Example. The multiplexed signal light from the optical transmitter 10 included 126 channels at optical frequency intervals of 100 GHz in the signal wavelength band of 1520 nm to 1620 nm and the optical power of each signal channel was 0 dBm. In each of Embodiment and Comparative Example the optical fiber transmission line 20 was a standard single-mode optical fiber and the length thereof was 100 km.

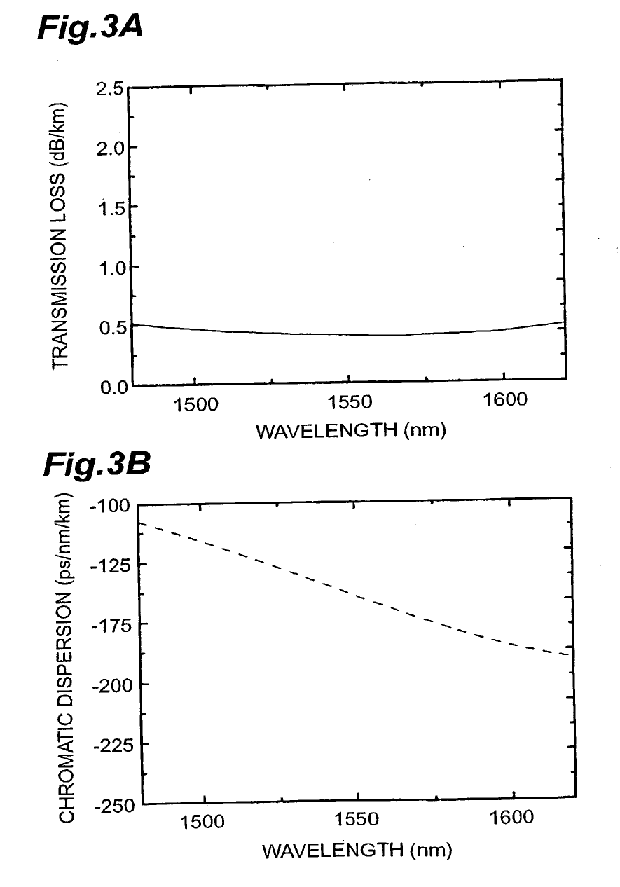

FIGS. 3A and 3B are graphs showing the transmission loss and chromatic dispersion characteristics of each of the optical fibers 341, 342 in the lumped optical amplifier 30 in the optical transmission system of Embodiment. Each of the optical fibers 341, 342 was designed in consideration of a trade-off between nonlinearity of fiber (a phase shift due to self-phase modulation) and Raman amplification characteristics and was one capable of compensating for the chromatic dispersion of the optical fiber transmission line 20 over a wide band. Each of the optical fibers 341, 342 had the length of 5.5 km. Comparative Example was configured in similar fashion.

Each of the optical fibers 341, 342 had, at the wavelength of 1480 nm, the transmission loss α of 0.51 dB/km, the chromatic dispersion of −109.2 ps/nm/km, the dispersion slope of −0.46 ps/nm²/km, FOM-d of 214.1 ps/nm/dB, the Raman gain coefficient g_{R} of 3.9 m/W, the effective area A_{eff} of 13 μm², and FOM-r of 1.6 (1/W/dB). Each of the optical fibers 341, 342 had, at the wavelength of 1550 nm, the transmission loss α of 0.40 dB/km, the chromatic dispersion of −147.7 ps/nm/km, the dispersion slope of −0.60 ps/nm²/km, FOM-d of 343.5 ps/nm/dB, the Raman gain coefficient g_{R} of 3.9 m/W, the effective area A_{eff} of 16 μm², and FOM-r of 5.1 (1/W/dB). Each of the optical fibers 341, 342 had, at the wavelength of 1600 nm, the transmission loss α of 0.42 dB/km, the chromatic dispersion of −173.4 ps/nm/km, the dispersion slope of −0.38 ps/nm²/km, FOM-d of 412.0 ps/nm/dB, the Raman gain coefficient g_{R} of 3.9 m/W, the effective area A_{eff} of 19 μm², and FOM-r of 6.5 (1/W/dB).

Here, in order to evaluate Raman gain characteristics free from the influence of the fiber length, the figure of merit of Raman (FOM-r) has been defined as the ratio of g_{R}/A_{eff} to α at the pumping wavelength. Also, in order to evaluate dispersion characteristics free from the influence of the fiber length the figure of merit of dispersion (FOM-d) has been defined as the ratio of chromatic dispersion to α at the signal wavelength.

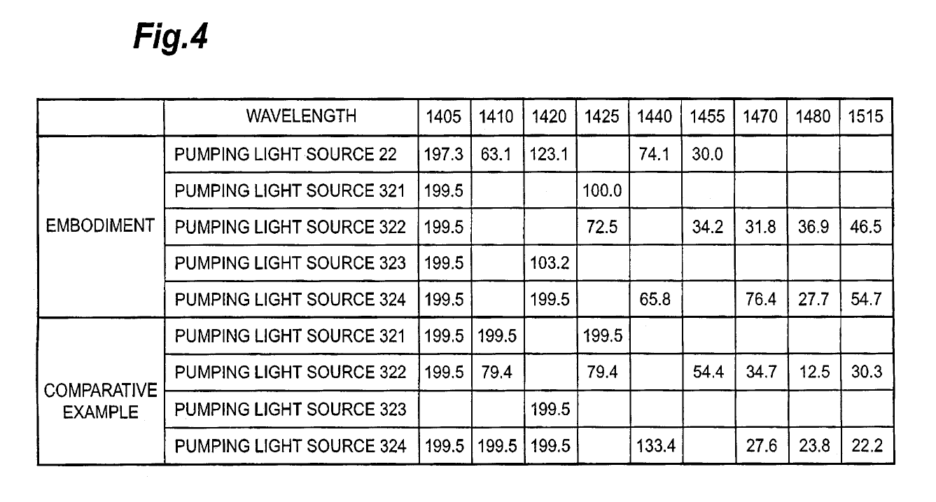

FIG. 4 is a table showing a list of wavelengths and powers of the Raman-amplification pumping light in each of Embodiment and Comparative Example. In this table each blank represents an unused wavelength.

In Embodiment, the Raman-amplification pumping light supplied from the pumping light source 22 into the optical fiber transmission line 20 included five channels of the respective wavelengths of 1405 nm (power 197.3 mW), 1410 nm (power 63.1 mW), 1420 nm (power 123.1 mW), 1440 nm (power 74.1 mW), and 1455 nm (power 30.0 mW). The Raman-amplification pumping light supplied in the forward direction from the pumping light source 321 into the optical fiber 341 included two channels of the respective wavelengths of 1405 nm (power 199.5 mW) and 1425 nm (power 100.0 mW). The Raman-amplification pumping light supplied in the backward direction from the pumping light source 322 into the optical fiber 341 included six channels of the respective wavelengths of 1405 nm (power 199.5 mW), 1425 nm (power 72.5 mW), 1455 nm (power 34.2 mW), 1470 nm (power 31.8 mW), 1480 nm (power 36.9 mW), and 1515 nm (power 46.5 mW). The Raman-amplification pumping light supplied in the forward direction from the pumping light source 323 into the optical fiber 342 included two channels of the respective wavelengths of 1405 nm (power 199.5 mW) and 1420 nm (power 103.2 mW). The Raman-amplification pumping light supplied in the backward direction from the pumping light source 324 into the optical fiber 342 included six channels of the respective wavelengths of 1405 nm (power 199.5 mW), 1420 nm (power 199.5 mW), 1440 nm (power 65.8 mW), 1470 nm (power 76.4 mW), 1480 nm (power 27.7 mW), and 1515 nm (power 54.7 mW).

In Comparative Example, there was no supply of Raman-amplification pumping light from the pumping light source 22 into the optical fiber transmission line 20. The Raman-amplification pumping light supplied in the forward direction from the pumping light source 321 into the optical fiber 341 included three channels of the respective wavelengths of 1405 nm (power 199.5 mW), 1410 nm (power 199.5 mW), and 1425 nm (power 199.5 mW). The Raman-amplification pumping light supplied in the backward direction from the pumping light source 322 into the optical fiber 341 included seven channels of the respective wavelengths of 1405 nm (power 199.5 mW), 1410 nm (power 79.4 mW), 1425 nm (power 79.4 mW), 1455 nm (power 54.4 mW), 1470 nm (power 34.7 mW), 1480 nm (power 12.5 mW), and 1515 nm (power 30.3 mW). The Raman-amplification pumping light supplied in the forward direction from the pumping light source 323 into the optical fiber 342 included one channel of the wavelength 1420 nm (power 199.5 mW). The Raman-amplification pumping light supplied in the backward direction from the pumping light source 324 into the optical fiber 342 included seven channels of the respective wavelengths of 1405 nm (power 199.5 mW), 1410 nm (power 199.5 mW), 1420 nm (power 199.5 mW), 1440 nm (power 133.4 mW), 1470 nm (power 27.6 mW), 1480 nm (power 23.8 mW), and 1515 nm (power 22.2 mW).

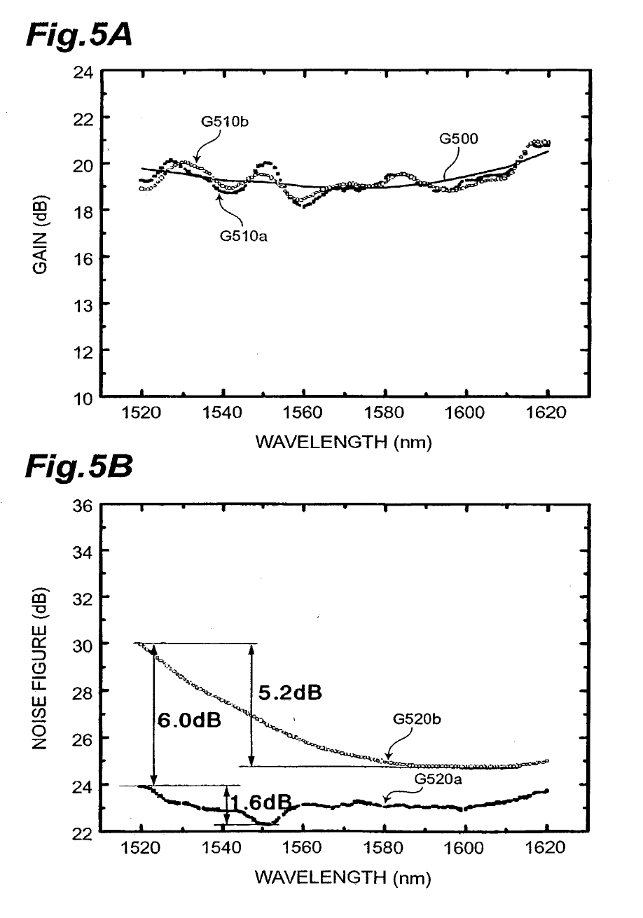

FIGS. 5A and 5B are graphs showing the gain and noise characteristics, respectively, in each of Embodiment and Comparative Example. As shown in these graphs, Embodiment and Comparative Example both achieved the gains at the same level as the transmission losses in the optical fiber transmission line 20. In Comparative Example the noise characteristic was degraded on the short wavelength side and the deviation of the noise figure in the signal wavelength band was 5.2 dB. In Embodiment the noise figure was improved by 6.0 dB on the short wavelength side when compared with Comparative Example and the variation of the noise figure in the signal wavelength band (=maximum noise figure−minimum noise figure) was 1.6 dB.

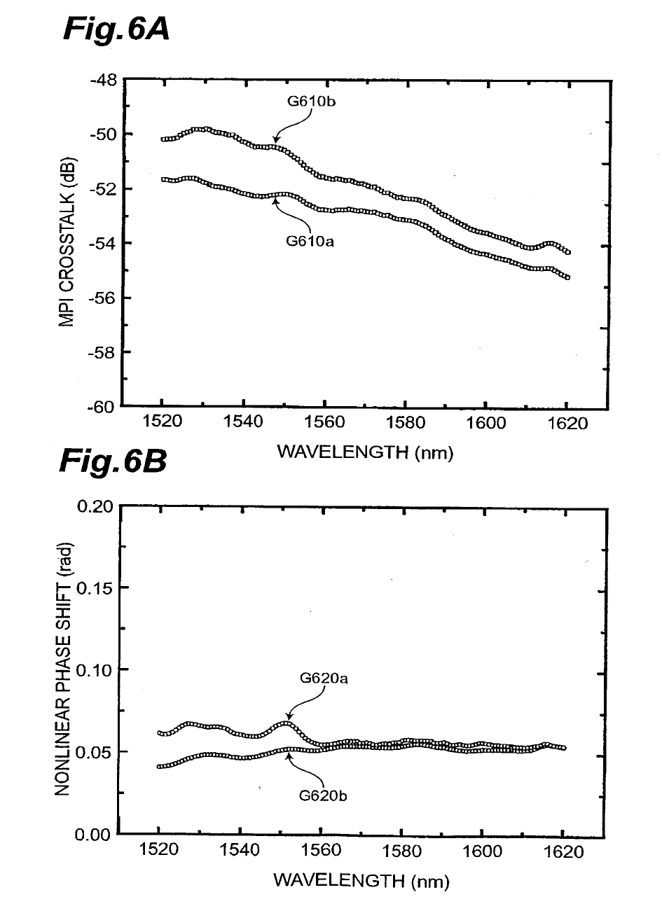

FIGS. 6A and 6B are graphs showing the MPI crosstalk (Multi-Path Interference Cross Talk) and nonlinear phase shift characteristics, respectively, in each of Embodiment and Comparative Example. The MPI crosstalk indicates the ratio of intensity of multi-path interference to intensity of signal light (cf. V. Curri, et al., “STATISTICAL PROPERTIES AND SYSTEM IMPACT OF MULTI-PATH INTERFERENCE IN RAMAN AMPLIFIERS”, Proc. 27th Eur. Conf. on Opt. Comm. (ECOC2001-Amsterdam) Tu.A.1.2). The nonlinear phase shift is caused by self-phase modulation occurring inside the optical transmission line. Embodiment demonstrated the good results of the both MPI crosstalk and nonlinear phase shift.

According to the present invention, as described above, the signal light with the plurality of signal channels is first Raman-amplified by the distributed Raman amplifier and thereafter is amplified by the lumped optical amplifier. The gain characteristic of the whole system is given by a total of the gain characteristics of the respective distributed Raman amplifier and lumped optical amplifier. The signal light outputted from the distributed Raman amplifier is one Raman-amplified so as to increase the power of the signal channels with decrease of their wavelength in the signal wavelength band and thereafter it is injected into the lumped optical amplifier. Accordingly, there is no need for increasing the gain on the short wavelength side in the signal wavelength band in the lumped optical amplifier, and thus the variation of the noise figure is largely improved in the whole system while the desired gain is secured.

What is claimed is:

1. An optical transmission system, comprising:
an optical fiber transmission line through which signal light with a plurality of signal channels of mutually different wavelengths in a signal wavelength band propagates; and
an optical device placed on said optical fiber transmission line, said optical device being capable of functioning as an element that degrades a noise characteristic in the signal wavelength band from the long wavelength side toward the short wavelength side when a desired gain is given to the signal light propagating in the optical fiber transmission line,
said optical transmission system further comprising a Raman amplifier placed upstream of said optical device with respect to a traveling direction of the signal light, wherein said Raman amplifier preliminarily Raman-amplifies the signal light to be injected into said optical device, so that optical powers of the signal channels in the signal wavelength band increase from the long wavelength side toward the short wavelength side.

2. An optical transmission system according to claim 1, wherein said optical device includes a lumped optical amplifier.

3. An optical transmission system according to claim 1, wherein said Raman amplifier comprises a pumping light source system for outputting pumping light having a plurality of pumping channels of mutually different wavelengths; and a distributed Raman amplifier provided with a part of said optical fiber transmission line located upstream of said optical device with respect to the traveling direction of the signal light, as an optical fiber for Raman amplification into which the pumping light from the pumping light source system is supplied,
wherein said distributed Raman amplifier adjusts optical powers of the respective pumping channels so that the optical powers of the signal channels in the Raman-amplified signal light increase from the long wavelength side toward the short wavelength side.

4. An optical transmission system according to claim 1, wherein a difference between an optical power in a signal channel of a shortest wavelength and an optical power in a signal channel of a longest wavelength in the signal wavelength band among the signal channels in the signal light outputted from said Raman amplifier, is 2 dB or more.

5. An optical transmission system according to claim 1, wherein, as a noise characteristic at an output port of said optical device, a difference between a minimum noise figure and a maximum noise figure in the signal wavelength band is 2 dB or less.

6. An optical amplification method in an optical transmission system comprising an optical fiber transmission line through which signal light with a plurality of signal channels of mutually different wavelengths in a signal wavelength band propagates; and an optical device placed on said optical fiber transmission line and being capable of functioning as an element that degrades a noise characteristic in the signal wavelength band from the long wavelength side toward the short wavelength side when a desired gain is given to the signal light propagating in said optical fiber transmission line, said optical amplification method comprising:
a first optical amplification step of supplying pumping light with a plurality of pumping channels into a part of said optical fiber transmission line located upstream of said optical device with respect to a propagating direction of the signal light and thereby preliminarily Raman-amplifying the signal light so that optical powers of the signal channels increase from the long wavelength side toward the short wavelength side in the signal wavelength band; and
a second optical amplification step being a step carried out subsequent to said first optical amplification step and being arranged to guide the Raman-amplified signal light to said optical device and further amplify the signal light in said optical device.

7. An optical amplification method according to claim 6, wherein said optical device includes a lumped optical amplifier.

8. An optical amplification method according to claim 6, wherein in said first optical amplification step, optical powers of the pumping channels in the pumping light each are adjusted so that the optical powers of the signal channels in the Raman-amplified signal light increase from the long wavelength side toward the short wavelength side.

9. An optical amplification method according to claim 6, wherein a difference between an optical power in a signal channel of a shortest wavelength and an optical power in a signal channel of a longest wavelength in the signal wavelength band among the signal channels in the signal light Raman-amplified in said first optical amplification step, is 2 dB or more.

10. An optical amplification method according to claim 6, wherein, as a noise characteristic after the amplification in said second optical amplification step, a difference between a minimum noise figure and a maximum noise figure in the signal wavelength band is 2 dB or less.
